(19) United States
(12) Patent Application Publication
(10) Pub. No.: US 2011/0095042 A1
(43) Pub. Date: Apr. 28, 2011

(54) STACK OF SHEETS AND SHEET CONTAINER

(75) Inventor: Takeshi Bandoh, Kagawa-ken (JP)

(73) Assignee: UNI-CHARM CORPORATION, Ehime-ken (JP)

(21) Appl. No.: 12/935,006

(22) PCT Filed: Mar. 30, 2009
(86) PCT No.: PCT/JP2009/056512

§ 371 Date: Dec. 13, 2010

(30) Foreign Application Priority Data
Mar. 31, 2008 (JP) 2008-094286

(51) Int. Cl. B65D 83/08; A47K 10/42; B32B 3/04; B65D 85/00

(52) U.S. Cl. 221/45; 428/124; 206/494

(57) ABSTRACT

It is an object of the invention to provide a technique for taking out folded sheets without increasing the height of a stack of sheets in a stacking direction. A representative stack of sheets includes first sheet bodies 12A, 12B each formed by folding a sheet and having a fold 12Aa, 12Ba and an opening 12ab, 12Bb and second sheet bodies 13A each formed by folding a sheet and then further folding the sheet in the same direction. The second sheet body 13A includes a fold 13Aa and an opening 13Ab fanned by the first folding and a gap 13c formed by the second folding. The fold and the opening of each of the first sheet bodies 12A, 12B are inserted into a region on the other side in the gap 13 in one of two second sheet bodies 13 such that the gaps 13 are open in the opposite directions with respect to each other and into a region on one side in the gap 13 in the stacking direction in the other second sheet body, respectively.

### BACKGROUND OF THE INVENTION

1. Field of the Invention

The invention relates to a technique of forming a stack of sheets by stacking a plurality of sheets one on another.

2. Description of the Related Art

Various kinds of sheets such as wet tissues are used to remove dirt on skin. In use, some users may fold a sheet taken out of a case. In this case, the users have to take the trouble to fold the sheet taken out of the case, so that the usability is impaired.

Therefore, a stack of sheets is provided from which a folded sheet can be taken out (see Japanese non-examined laid-open Patent Publication No. H03-332985). This stack of sheets consists of sheet bodies each of which is formed by folding a sheet and then further folding it in the same direction and has a fold and an opening which are formed by the first folding and a gap formed by the second folding. The stack of sheets is formed by stacking the sheet bodies one on another in such a manner that the gaps are open alternately in the opposite directions with respect to each other along the stacking direction and such that the sheet bodies (folded sheets) can be taken out one by one.

### SUMMARY OF THE INVENTION

The known stack of sheets consists of sheet bodies each formed by folding a sheet and then further folding it in the same direction. Therefore, the height of the stack of sheets in the stacking direction is increased. Accordingly, the height of the case that contains the stack of sheets is increased.

It is, accordingly, an object of the invention to provide a technique for taking out folded sheets without increasing the height of a stack of sheets in a stacking direction.

One aspect of the invention relates to a stack of sheets which is formed by stacking a plurality of sheets one on another. The stack of sheets can be formed by stacking various kinds of sheets such as wet tissues. The sheets are typically quadrangular (square or rectangular).

In this invention, the stack of sheets consists of first sheet bodies and second sheet bodies which are formed by folding the sheets. Each of the first sheet bodies is formed by folding a sheet once and has a fold and an opening. The first sheet body is typically formed by folding a quadrangular sheet along a folding line extending from a center of one side of the quadrangular sheet in parallel to the other side which crosses the one side. Further, each of the second sheet bodies is formed by folding a sheet and then further folding it in the same direction (by folding the sheet twice) and has a fold and an opening which are formed by the first folding and a gap formed by the second folding. The second sheet body is typically formed by folding a quadrangular sheet along a folding line extending from a center of one side of the quadrangular sheet in parallel to the other side which crosses the one side and further folding the sheet along a folding line extending from a center of a side corresponding to the one side in parallel to the other side. Naturally, the folding positions of the first and second sheet bodies can be appropriately selected.

The first sheet bodies are arranged along the stacking direction in such orientation that the folds and the openings are alternately reversed in position with respect to a direction perpendicular to the stacking direction, when viewed from the direction perpendicular to the folding lines of the first sheet bodies (from the direction of the width). Further, the second sheet bodies are arranged along the stacking direction with a predetermined spacing in the direction perpendicular to the stacking direction such that the gaps are open in the directions that face each other and such that the fold of the second sheet body is placed to one side (take-out opening side) of the opening in the stacking direction, when viewed from the direction perpendicular to the folding lines of the second sheet bodies (from the direction of the width). Typically, the second sheet bodies consist of second sheet bodies of a first group and second sheet bodies of a second group which are arranged along the stacking direction with a predetermined spacing in the stacking direction. In this case, each of the second sheet bodies of the first and second groups is arranged such that the fold of the second sheet body is placed to one side of the opening in the stacking direction and such that the gaps of the second sheet bodies of the first and second groups are open in the directions that face each other. Further, the fold and the opening of each of the first sheet bodies are inserted into a region on the other side in the gap in the stacking direction in one of two second sheet bodies oriented such that the gaps are open in the opposite directions with respect to each other and into a region on one side in the gap in the stacking direction in the other second sheet body, respectively. Typically, the fold and the opening of the first sheet body are inserted into the gap of the second sheet body of the first group and the gap of the second sheet body of the second group, respectively. The “one side in the stacking direction” typically represents the side (take-out opening side) from which the first or second sheet bodies are taken out.

In this invention, sheets can be taken out in the folded state (the first sheet bodies or the second sheet bodies), so that the usability is enhanced. Further, the stack of sheets is formed by stacking first sheet bodies each Ruined by folding a sheet once and the second sheet bodies each formed by folding a sheet twice, so that the height of the stack of sheets in the stacking direction can be reduced. Further, the fold and the opening of each of the first sheet bodies are inserted respectively into the gaps of two second sheet bodies which are oriented such that the gaps are open in the opposite directions with respect to each other, respectively. With this arrangement, when the stack of sheets according to this invention is contained in a case with a take-out opening, the amount of the part of the first or second sheet body to be exposed (drawn out) through the take-out opening can be reduced.

In another embodiment according to this invention, the opening of the first sheet body inserted into the region on one side in the gap in the stacking direction in the second sheet body is placed in a position displaced to the open side of the gap of said second sheet body from the fold of the first sheet body inserted into the region on the other side in the gap in the stacking direction in said second sheet body, when viewed from the direction perpendicular to the folding lines of the first and second sheet bodies.

In this embodiment, the contact area between the two first sheet bodies inserted into the gap of the second sheet body along the stacking direction can be reduced. As a result, when the first sheet body inserted into a region on one side in the gap in the stacking direction is taken out, the fold side of the first sheet body inserted into a region on the other side in the same gap in the stacking direction can be prevented from being exposed (drawn out).

In a further embodiment according to this invention, the second sheet body is folded in such a manner that the fold of the second sheet body is placed in a position displaced from the opening of the second sheet body to an open side of the gap, when viewed from the direction perpendicular to the folding lines of the first and second sheet bodies.

In this embodiment, even if the opening of the first sheet body inserted into the region on one side in the gap of the second sheet body in the stacking direction is placed in a position displaced to the open side of the gap of the second sheet body from the fold of the first sheet body inserted into the region on the other side in the gap of the second sheet body, increase of the width of the stack of sheets can be prevented.

In a further embodiment according to this invention, wet tissues are used as the sheets. In this embodiment, the wet tissues can be suitably stacked one on another.

Another aspect of the invention relates to a sheet container which includes a case with a take-out opening and a stack of sheets which is formed by stacking a plurality of sheets one on another and contained within the case, and from which sheets forming the stack of sheets are taken out one by one through the take-out opening of the case. In this invention, any one of the above-described stacks of sheets is used as the stack of sheets.

In this invention, the height of the sheet container can be reduced.

A further invention relates to a sheet container which includes a case with a take-out opening and a stack of sheets which is formed by stacking a plurality of sheets one on another and contained within the case, and from which sheets forming the stack of sheets are taken out one by one through the take-out opening of the case.

In this invention, the stack of sheets consists of first sheet bodies and second sheet bodies which are formed by folding each of the sheets. Each of the first sheet bodies is formed by folding a sheet once and has a fold and an opening. The first sheet body is typically formed by folding a quadrangular sheet along a folding line extending from a center of one side of the quadrangular sheet in parallel to the other side which crosses the one side. Further, each of the second sheet bodies is formed by folding a sheet and then further folding it in the same direction and has a fold and an opening which are formed by the first folding and a gap formed by the second folding. The second sheet body is typically formed by folding a quadrangular sheet along a folding line extending from a center of one side of the quadrangular sheet in parallel to the other side which crosses the one side and further folding the sheet along a folding line extending from a center of a side corresponding to the one side in parallel to the other side. Naturally, the folding positions of the first and second sheet bodies can be appropriately selected.

The stack of sheets is formed by stacking the first sheet bodies and the second sheet bodies one on another. The first sheet bodies and the second sheet bodies are stacked one on another in such a manner that, when the first sheet body or second sheet body lying on an end of the stack of sheets which faces the take-out opening of the case is taken out, the fold of the second sheet body or first sheet body which immediately underlies said first sheet body or second sheet body is exposed (drawn out) through the take-out opening. Various manners can be used to stack the first sheet bodies and the second sheet bodies one on another.

In this invention, sheets can be taken out in the folded state (the first sheet bodies or the second sheet bodies), so that the usability is enhanced. Further, the stack of sheets is formed by stacking first sheet bodies each formed by folding a sheet once and the second sheet bodies each formed by folding a sheet twice, so that the height of the stack of sheets in the stacking direction can be reduced.

As a result, according to the invention, sheets can be taken out in the folded state without increasing the height of a stack of sheets or the height of a sheet container.

### BRIEF DESCRIPTION OF THE DRAWINGS

FIG. 1 shows a first sheet body forming a stack of sheets according to an embodiment of the invention.

FIG. 2 shows a second sheet body forming the stack of sheets according to the embodiment.

FIG. 3 shows the stack of sheets as viewed from the direction perpendicular to folding lines of the first and second sheet bodies.

FIG. 4 shows a sheet container which contains the stack of sheets in a case.

FIG. 5 shows the state in which a sheet is taken out of the stack of sheets.

FIG. 6 shows a sheet container which contains a stack of sheets according to another embodiment in a case.

### DETAILED DESCRIPTION OF THE INVENTION

### First Representative Embodiment

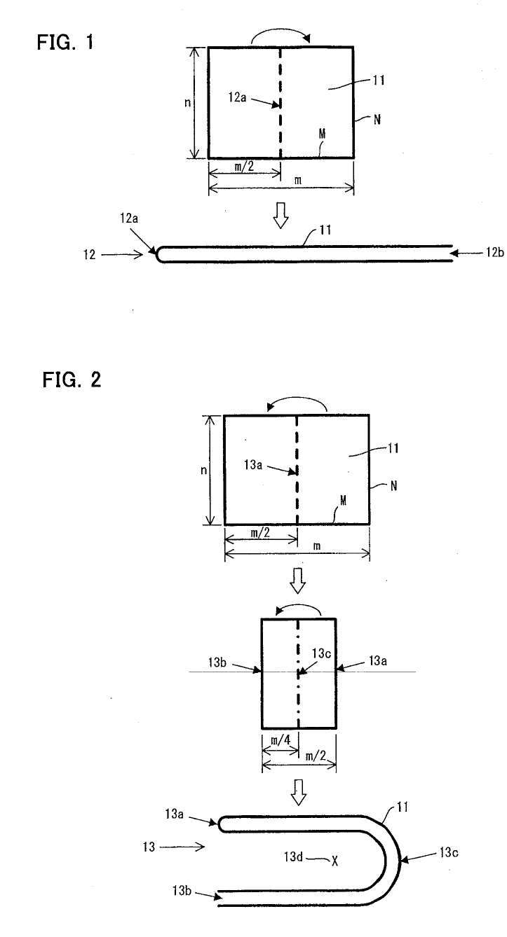

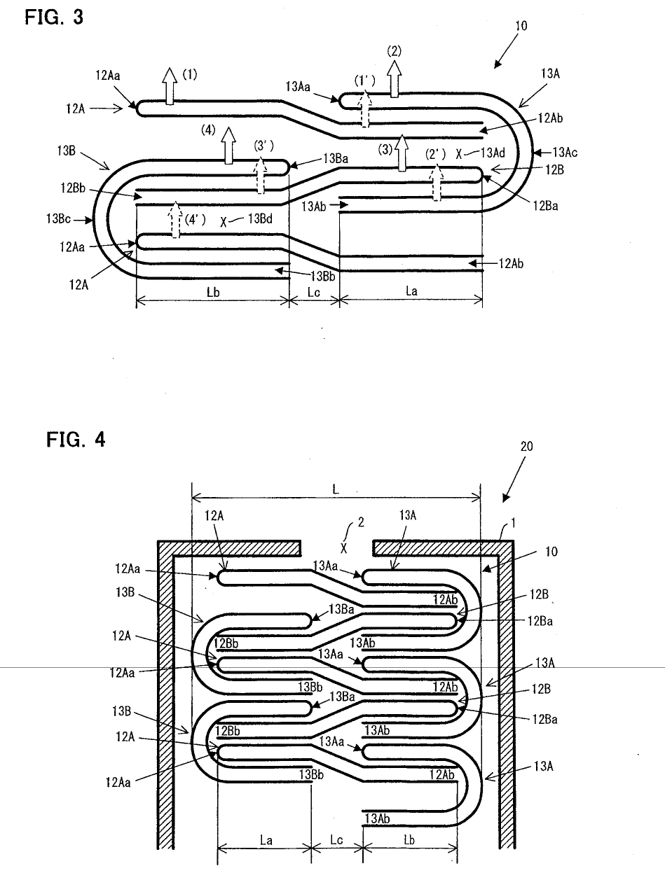

A first embodiment of the invention is now described with reference to FIGS. 1 to 4. In this embodiment, a stack of wet tissues (sheets) is described as an representative example of the invention. FIG. 1 shows a first sheet body 12 formed by folding a sheet 11 once, as viewed from a direction perpendicular to the folding line (from the direction of the width). FIG. 2 shows a second sheet body 13 formed by folding the sheet 11 twice, as viewed from a direction perpendicular to the folding line (from the direction of the width). FIG. 3 shows a stack of sheets 10 formed by stacking first and second sheet bodies 12 and 13 one on another, as viewed from a direction perpendicular to the folding lines (from the direction of the width). FIG. 4 shows a sheet container 20 which contains the stack of sheets 10 according to this embodiment in a case 1, as viewed from a direction perpendicular to the folding lines (from the direction of the width).

As shown in FIGS. 1 and 2, for example, the wet tissue 11 is an impregnated sheet of a rectangular shape having a long side M (having a length m) and a short side N (having a length n). Naturally, the wet tissue 11 can be provided in various shapes such as a square (m=n). The impregnated sheet is formed by impregnating a base sheet with impregnating liquid. The base sheet may be, for example, a sheet made of pulp, a sheet made of pulp and thermoplastic resin, or a sheet made of nonwoven fabric. The impregnating liquid may be, for example, water or water-soluble alcohol.

The stack of sheets 10 of this embodiment consists of first sheet bodies 12 and second sheet bodies 13 which are formed by folding wet tissues 11.

As shown in FIG. 1, each of the first sheet bodies 12 is formed by folding a wet tissue 11. In this embodiment, the wet tissue 11 is folded along a folding line (dashed line in FIG. 1) extending from a center of one side (long side M) of the wet tissue 11 in parallel to a side (short side N) which crosses the one side. Thus, the first sheet body 12 has a fold 12a and an opening 12b of a gap formed by folding. In FIG. 1, the wet tissue 11 is folded at a center of one side (long side M) so that the opening is formed in a position where the opposite ends of the one side (long side M) face each other. The position of the opening 12b, however, varies by the folding position.

As shown in FIG. 2, the second sheet body 13 is formed by folding a wet tissue 11 once and then folding it again in the same direction. In this embodiment, first, the wet tissue 11 is folded along a folding line (dashed line in FIG. 2) extending from a center of one side (long side M) of the wet tissue 11 in parallel to a side (short side N) which crosses the one side. Secondly, the wet tissue 11 is folded along a folding line (chain line in FIG. 2) extending from a center of a side corresponding to the one side in parallel to the side (short side N) which crosses the side corresponding to the one side. Thus, the second sheet body 13 has a fold 13a and an opening 13b which are formed by the first folding (along the dashed line) and a fold 13c and a gap 13d which are formed by the second folding (along the chain line).

Then, the first sheet bodies 12 and the second sheet bodies 13 are stacked one on another to form the stack of sheets 10. The first sheet bodies 12 and the second sheet bodies 13 are stacked one on another in such a manner that, when a first sheet body 12 or second sheet body 13 which lies on the end of the stack of sheets on one side in the stacking direction (on the upper end in FIG. 3) is pulled away from the stack of sheets 10 one by one, a fold of a second sheet body 13 or first sheet body 12 which immediately underlies the first sheet body 12 or second sheet body 13 is also pulled away from the stack of sheets 10.

In this embodiment, the first sheet bodies 12 and the second sheet bodies 13 are stacked one on another in the following manner.

The first sheet bodies 12 are arranged along the stacking direction (a vertical direction in FIG. 3) in such orientation that the folds 12a and the openings 12b are alternately reversed in position with respect to a direction perpendicular to the stacking direction (to a lateral direction in FIG. 3), when viewed from the direction perpendicular to the folding lines of the first sheet bodies 12 (from the direction of the width). In the following description, the first sheet bodies 12 which are arranged in one orientation with respect to the positions of the folds 12a and the openings 12b are designated by 12A, while the other first sheet bodies 12 which are arranged in the other orientation (in reversed orientation) are designated by 12B. In FIG. 3, the first sheet bodies 12A are arranged with the folds 12Aa on the left (on one side with respect to the direction perpendicular to the stacking direction) and the openings 12Ab on the right (on the other side with respect to the direction perpendicular to the stacking direction). Further, the first sheet bodies 13A are arranged with the folds 12Ba on the right (on the other side with respect to the direction perpendicular to the stacking direction) and the openings 12Bb on the left (on the one side with respect to the direction perpendicular to the stacking direction).

The second sheet bodies 13 are arranged along the stacking direction (the vertical direction in FIG. 3) with a predetermined spacing Lc in the direction perpendicular to the stacking direction (in the lateral direction in FIG. 3), when viewed from the direction perpendicular to the folding lines of the second sheet bodies 13 (from the direction of the width). Further, the second sheet bodies 13 are arranged such that the folds 13a are located to one side of (above in FIG. 3) the openings 13b in the stacking direction and the gaps 13d are open toward the center of the stack of sheets. In the following description, the second sheet bodies 13 (the second sheet bodies 13 of a first group) which are arranged such that the gaps 13d are open to the one side in the direction perpendicular to the stacking direction are designated by 13A, while the other second sheet bodies 13 (the second sheet bodies 13 of a second group) which are arranged such that the gaps 13d are open to the other side are designated by 13B. In FIG. 3, the second sheet bodies 13A (the second sheet bodies 13A of the first group) are arranged such that the gaps 13Ad are open to the left (to the one side with respect to the direction perpendicular to the stacking direction), while the second sheet bodies 13B (the second sheet bodies 13B of the second group) are arranged such that the gaps 13Bd are open to the right (to the other side with respect to the direction perpendicular to the stacking direction).

The fold 12a and the opening 12b of each of the first sheet bodies 12 are inserted into a region on the other side in the gap 13d in the stacking direction (a lower region of the gap in FIG. 3) in one (the second sheet body 13 of one group) of the two second sheet bodies 13 which are oriented to open in the opposite directions with respect to the direction perpendicular to the stacking direction (to the lateral direction in FIG. 3) and into a region on one side in the gap 13d in the stacking direction (an upper region of the gap in FIG. 3) in the other second sheet body 13 (the second sheet body 13 of the other group), respectively, when viewed from the direction perpendicular to the folding lines of the first and second sheet bodies 12, 13 (from the direction of the width).

In FIG. 3, in the gap 13Ad of the second sheet body 13A (the second sheet body 13A of the first group) which is oriented to open to the left (to the one side with respect to the direction perpendicular to the stacking direction), the opening 12Ab of the first sheet body 12A is inserted into an upper region of the gap 13Ad (on one side in the stacking direction), and the fold 12Ba of the first sheet body 12B underlying the first sheet body 12A (or located to the other side of the first sheet body 12A in the stacking direction) is inserted into a lower region of the gap 13Ad (on the other side in the stacking direction). Further, in the gap 13Bd of the second sheet body 13B (the second sheet body 13B of the second group) which is oriented to open to the right (to the other side with respect to the direction perpendicular to the stacking direction), the opening 12Bb of the first sheet body 12B is inserted into an upper region of the gap 13Bd (on one side in the stacking direction), and the fold 12Aa of the first sheet body 12A underlying the first sheet body 12B (located to the other side of the first sheet body 12B in the stacking direction) is inserted into a lower region of the gap 13Bd (on the other side in the stacking direction).

The fold 12Aa side of the first sheet body 12A is inserted a length La into the gap 13Bd of the second sheet body 13B, and the fold 12Ba side of the first sheet body 12B is inserted a length La into the gap 13Ad. Further, the opening 12Ab side of the first sheet body 12A is inserted a length Lb into the gap 13Ad of the second sheet body 13A, and the opening 12Bb side of the first sheet body 12B is inserted a length Lb into the gap 13Bd of the second sheet body 13B. In this embodiment, it is set such that La=Lb. Further, the stack of sheets 10 has a width of L.

Further, the sheet body lying on the end on one side in the stacking direction (on the upper end in FIG. 3) and the sheet body on the end on the other side in the stacking direction (on the lower end in FIG. 3) of the stack of sheets 10 are stacked in a different state. For example, as shown in FIG. 3, on the end on one side in the stacking direction (on the upper end in FIG. 3) of the stack of sheets 10, the fold 12Aa of the first sheet body 12A is not inserted into a gap 13d of a second sheet body 13.

The stack of sheets 10 formed by stacking the first sheet bodies 12 (12A, 12B) and the second sheet bodies 13 (13A, 13B) one on another is contained in the case 1 of the sheet container 20 shown in FIG. 4. A sheet take-out opening 2 is formed in the case 1. The first sheet bodies 12 (12A, 12B) and the second sheet bodies 13 (13A, 13B) which form the stack of sheets 10 are taken out through the take-out opening 2 one by one. In this embodiment, the stack of sheets 10 is contained within the case 1 with the upper side (one side in the stacking direction) in FIG. 3 on the take-out opening 2 side of the case 1.

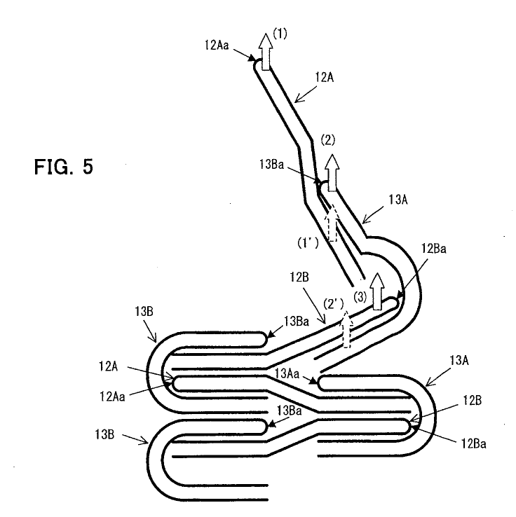

Taking out the first sheet bodies 12 (12A, 12B) and the second sheet bodies 13 (13A, 13B) through the take-out opening 2 of the case 1 is now described with reference to FIGS. 3 and 5. In order to take out the first sheet body 12A lying on the upper end (on one side in the stacking direction) of the stack of sheets 10, the fold 12Aa side of the first sheet body 12A is pulled in an upward direction (in the direction of the one side in the stacking direction) shown by a solid arrow (1) through the take-out opening 2 away from the stack of sheets 10. At this time, the opening 12Ab side of the first sheet body 12A is also pulled in the upward direction (in the direction of the one side in the stacking direction) shown by a dotted arrow (1′). In this embodiment, the opening 12Ab of the first sheet body 12A is inserted into the upper region of the gap 13Ad (on one side in the stacking direction) of the second sheet body 13A. Therefore, when the opening 12Ab side of the first sheet body 12A is pulled in the upward direction shown by the dotted arrow (1′), the fold 13Aa side of the second sheet body 13A is also pulled upward by friction between the opening 12Ab side of the first sheet body 12A and the fold 13Aa side of the second sheet body 13A. Then, when the first sheet body 12A is taken out through the take-out opening 2, the fold 13Aa side of the second sheet body 13A is partially exposed (drawn out) through the take-out opening 2.

In this case, the material of the first and second sheet bodies 12A, 12B, the contact area between the first sheet bodies 12A and the second sheet bodies 12B (for example, the contact lengths La, Lb in the direction perpendicular to the stacking direction), and the shape of the take-out opening 2 are set such that, when the first sheet body 12A is taken out through the take-out opening 2, the fold 13Aa side of the second sheet body 13A to be taken out next is partially drawn out through the take-out opening 2.

Next, in order to take out the second sheet body 13A, the drawn-out fold 13Aa side of the second sheet body 13A is pulled in an upward direction shown by a solid arrow (2) away from the stack of sheets 10. At this time, the opening 13Ab side of the second sheet body 13A is also pulled in the upward direction shown by a dotted arrow (2′). In this embodiment, the fold 12Bb of the first sheet body 12B is inserted into the lower region of the gap 13Ad (on the other side in the stacking direction) of the second sheet body 13A. Therefore, when the opening 13Ab side of the second sheet body 13A is pulled in the upward direction shown by the dotted arrow (2′), the fold 12Ba side of the first sheet body 12B is also pulled upward by friction between the opening 13Ab side of the second sheet body 13A and the fold 12Ba side of the first sheet body 12B. Then, when the second sheet body 13A is taken out through the take-out opening 2, the fold 12Ba side of the first sheet body 12B is partially exposed (drawn out) through the take-out opening 2.

In the same manner, when the partially drawn-out fold 12Ba side of the first sheet body 12B is pulled upward, the first sheet body 12B is taken out, and at the same time, the fold 13Ba side of the second sheet body 13B to be taken out next is partially exposed (drawn out) through the take-out opening 2. Thereafter, when the partially drawn-out fold 13Ba side of the second sheet body 13B is pulled upward, the second sheet body 13B is taken out, and at the same time, the fold 12Aa side of the first sheet body 12A to be taken out next is partially exposed (drawn out) through the take-out opening 2.

As described above, in this embodiment, the stack of sheets 10 is formed by stacking the first sheet bodies and the second sheet bodies one on another. Each of the first sheet bodies is formed by folding a wet tissue 11 and has the fold and the opening, and each of the second sheet bodies is formed by folding a wet tissue 11 once and then folding again in the same direction and has the fold and the opening which are formed by the first folding and the gap formed by the second folding. With this arrangement, the height of the stack of sheets 10 in the stacking direction can be reduced. For example, the height of the stack of sheets in the stacking direction can be reduced to two thirds compared with the known stack of sheets disclosed in the reference. Accordingly, the height of the case 1 that contains the stack of sheets 10 and thus the height of the sheet container 20 can be reduced. Further, by reduction of the height of the case 1, when the case is low on sheets, sheets can be easily taken out by reaching through the take-out opening with the fingers. Further, by reduction of the height of the stack of sheets 10, the number of sheets which can be contained within the case 1 of the same height can be increased.

Further, the sheets are taken out through the take-out opening 2 of the case 1 in the folded state (the first sheet bodies 12 or the second sheet bodies 13), so that the users do not have to take the trouble to fold the taken-out sheets. Therefore, the usability is enhanced.

Further, the second sheet bodies 13 are arranged along the stacking direction with a predetermined spacing Lc therebetween in the direction perpendicular to the stacking direction such that the gaps are open in the directions that face each other. Further, the fold and the opening of each of the first sheet bodies are inserted respectively into the gaps of two second sheet bodies 13 (the gap of the second sheet body of the first group and the gap of the second sheet body of the second group). With this arrangement, the amount of the part of the first or second sheet body 12 or 13 to be exposed (drawn out) through the take-out opening 2 can be reduced. This is particularly effective in using wet tissues as the sheets.

### Second Representative Embodiment

If the contact area between the first sheet body 12A and the first sheet body 12B which are placed in the gap 13Ad of the second sheet body 13A (or the contact area between the first sheet body 12B and the first sheet body 12A which are placed in the gap 13Bd of the second sheet body 13B) is large, when the first sheet body 12A (or the first sheet body 12B) is taken out, the fold 12Ba side of the first sheet body 12B (or the fold 12Aa side of the first sheet body 12A) may also be exposed (drawn out) through the take-out opening 2.

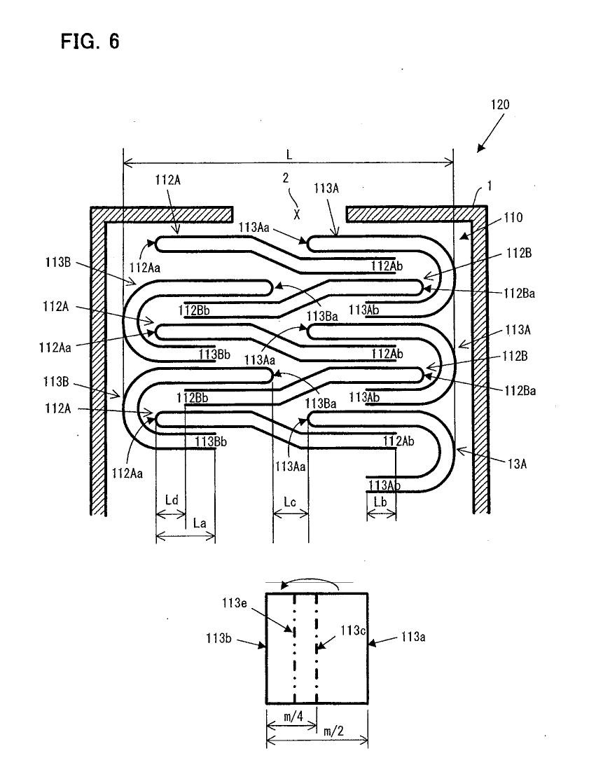

In this connection, FIG. 6 shows second representative embodiment of the invention so as to prevent this problem.

In the second representative embodiment, in order to reduce the contact area between the first sheet body 12 inserted into the upper region of the gap 13d (on one side in the stacking direction) of the second sheet body 13 and the first sheet body 12 inserted into the lower region of the gap 13d (on the other side in the stacking direction), the opening 12b of the first sheet body 12 inserted into the upper region of the gap 13d is placed in a position displaced to the open side of the gap 13d from the fold 12a of the first sheet body 12 inserted into the lower region of the gap.

Specifically, as shown in FIG. 6, the opening 112Ab of the first sheet body 112A inserted into the upper region of the gap 113Ad of the second sheet body 113A is placed in a position displaced a distance Ld to the open side of the gap 113Ad from the fold 112Ba of the first sheet body 112B inserted into the lower region of the gap 113Ad. Further, the opening 112Bb of the first sheet body 112B inserted into the upper region of the gap 113Bd of the second sheet body 113B is placed in a position displaced a distance Ld to the open side of the gap 113Bd from the fold 112Aa of the first sheet body 112A inserted into the lower region of the gap 113Bd.

Further, second sheet bodies 113a (113A, 113B) are formed by folding a sheet along a folding line extending from a center of a side corresponding to one side (long side M) of the sheet in parallel to a side (short side N) which crosses the side corresponding to the one side, as shown by chain line in FIG. 6. In this case, however, a width L of the stack of sheets may become too large. In order to prevent this, in this embodiment, the sheet is further folded along a folding line extending from a position displaced from a center of a side corresponding to the one side (long side M) of the sheet in parallel to the side (short side N) which crosses the side corresponding to the one side, as shown by two-dot chain line in FIG. 6. Thus, second sheet bodies 113 (113A, 113B) are formed. In FIG. 6, each of the second sheet bodies 113A is folded in such a manner that a fold 113Aa is placed in a position displaced from an opening 113Ab to the open side of a gap 113Ad. Likewise, each of the second sheet bodies 113B is folded in such a manner that a fold 113Ba is placed in a position displaced from an opening 113Bb to the open side of a gap 113Bd.

In this embodiment, when the opening side of the first sheet body which is placed in the upper region of the gap (on one side in the stacking direction) is taken out, the fold side of the first sheet body which is placed in the lower region of the same gap (on the other side in the stacking direction) can be prevented from being exposed (drawn out) through the take-out opening. Further, with the arrangement in which the fold and the opening of the second sheet body are displaced in position from each other when viewed from the direction perpendicular to the folding lines of the first and second sheet bodies, increase of the width of the stack of sheets can be prevented.

The invention is not limited to the construction of the above-described embodiment, but rather, may be added to, changed, replaced with alternatives or otherwise modified.

In the above embodiment, a technique of stacking wet tissues one on another is described, but the technique described herein can be applied to stacking of various kinds of sheets.

As a manner of stacking the first sheet bodies and the second sheet bodies one on another, various manners can be used in which the first or second sheet body lying on the end on one side of the stack of sheets can be taken out one by one. In other words, the invention can be designed as a “stack of sheets having first sheet bodies and second sheet bodies” or a “stack of sheets formed by stacking first sheet bodies and second sheet bodies one on another”.

Each of the constructions described in the above embodiment can be used by itself or in combination of appropriately selected ones of the constructions.

### DESCRIPTION OF NUMERALS

1 case
2 take-out opening
10, 110 stack of sheets
11 wet tissue (sheet)
12, 12A, 12B, 112A, 112B first sheet body
13, 13A, 13B, 113A, 113B second sheet body
12a, 13a, 12Aa, 12Ba, 13Aa, 13Ba, 112Aa, 112Ba first folding line
12b, 13b, 12Ab, 12Bb, 13Ab, 13Bb opening
13c second folding line
13d gap
20, 120 sheet container

1. A stack of sheets formed by stacking a plurality of sheets one on another comprising:
first sheet bodies each formed by folding a sheet and having a fold and an opening, and
second sheet bodies each formed by folding a sheet and then further folding the sheet in the same direction, the second sheet body having a fold and an opening which are formed by the first folding and a gap formed by the second folding, wherein:
the first sheet bodies are arranged along a stacking direction in such orientation that the folds and the openings are alternately reversed in position with respect to a direction perpendicular to the stacking direction,
the second sheet bodies are arranged along the stacking direction with a predetermined spacing in the direction perpendicular to the stacking direction such that the gaps are open in the directions that face each other and such that the fold of the second sheet body is placed to one side of the opening in the stacking direction, and
the fold and the opening of each of the first sheet bodies are inserted into a region on the other side in the gap in the stacking direction in one of two second sheet bodies oriented such that the gaps are open in the opposite directions with respect to each other and into a region on one side in the gap in the stacking direction in the other second sheet body, respectively.

2. The stack of sheets as defined in claim 1, wherein the opening of the first sheet body inserted into the region on one side in the gap in the stacking direction in the second sheet body is placed in a position displaced to the open side of the gap of said second sheet body from the fold of the first sheet body inserted into the region on the other side in the gap in the stacking direction in said second sheet body.

3. The stack of sheets as defined in claim 2, wherein the second sheet body is folded in such a manner that the fold of the second sheet body is placed in a position displaced from the opening of the second sheet body to an open side of the gap.

4. The stack of sheets as defined in claim 1, wherein wet tissues are used as the sheets.

5. A sheet container, including a case with a take-out opening and a stack of sheets which is formed by stacking a plurality of sheets one on another and contained within the case, and from which sheets forming the stack of sheets are taken out one by one through the take-out opening of the case, wherein:
the stack of sheets as defined in claim 1 is used as the stack of sheets.

6. A sheet container, including a case with a take-out opening and a stack of sheets which is formed by stacking a plurality of sheets one on another and contained within the case, and from which sheets forming the stack of sheets are taken out one by one through the take-out opening of the case, comprising:
first sheet bodies each formed by folding a sheet and having a fold and an opening, and
second sheet bodies each formed by folding a sheet and then further folding in the same direction, the second sheet body having a fold and an opening which are formed by the first folding and a gap formed by the second folding, wherein:
the stack of sheets is formed by stacking the first sheet bodies and the second sheet bodies one on another, and
the first sheet bodies and the second sheet bodies are stacked one on another in such a manner that, when the first sheet body or second sheet body lying on an end of the stack of sheets which faces the take-out opening of the case is taken out, the fold of the second sheet body or first sheet body which immediately underlies said first sheet body or second sheet body is exposed through the take-out opening.
